(19) United States
(12) Patent Application Publication
(10) Pub. No.: US 2026/0054995 A1
(43) Pub. Date: Feb. 26, 2026

(54) LIGNITE BASED ACTIVATED CARBON AND METHOD OF MAKING

(71) Applicant: Norit Americas, Inc., Marshall, TX (US)

(72) Inventors: Lee W. BROWN, Longview, TX (US); Edward Charles WEINTROB, Edmond, OK (US); Regina RODRIGUEZ, Gainesville, FL (US)

(73) Assignee: Norit Americas, Inc., Marshall, TX (US)

(21) Appl. No.: 19/307,234

(22) Filed: Aug. 22, 2025

Related U.S. Application Data
(60) Provisional application No. 63/686,287, filed on Aug. 23, 2024.

(51) Int. Cl. C01B 32/318

(52) U.S. Cl. CPC C01B 32/318; C01P 2004/60; C01P 2006/10

(57) ABSTRACT

A method is described for pre-drying lignite prior to steam activation to produce activated carbon with improved physical properties. Dried lignite results in significantly higher yields of granular product, increased hardness, and comparable adsorption performance. The process supports higher throughput and reduced fines, with specific benefits demonstrated for biogas H₂S removal applications.

### RELATED APPLICATIONS

This application claims benefit of U.S. Provisional Application No. 63/686,287 filed on Aug. 23, 2024 and titled LIGNITE BASED ACTIVATED CARBON AND METHOD OF MAKING. The contents are incorporated by reference herein in their entirety.

### FIELD OF THE DISCLOSURE

This disclosure relates to activated carbon and a method of making activated carbon from dried lignite. More particularly, it concerns improved yield, hardness, and size distribution of activated carbon products via controlled pre-drying of lignite feedstock prior to steam activation.

### BACKGROUND

Many different sources of carbon can be used as the raw material to make activated carbon. One source is coal, including anthracite, bituminous, subbituminous, and lignite. When lignite is activated, there are often losses in the production process due to the softness and a reduction in particle size of the resulting activated carbon. A process that results in a higher yield of larger, harder particles would be an advancement in the field.

### SUMMARY

Aspects of the present disclosure relate to a process of drying lignite prior to activation. By reducing the moisture content of the feedstock to 15-20 wt %, the resulting activated carbon can exhibit a 48% increase in on-size product yield (e.g., 4×12 or 6×12 mesh), improved ball pan hardness (threefold increase), and minimal impact on adsorption.

### BRIEF DESCRIPTION OF THE DRAWINGS

FIG. 1 illustrates the furnace yield and the 4×12 granule size yield at various hold times for material produced by one embodiment;

FIG. 2 provides data for vibratory feed density (VFD) and H₂S capacity on conventionally processed, undried lignite;

FIG. 3 provides data for furnace yield and 4×12 yield with lignite samples at their natural moisture content (31%), dried to 20% moisture, and dried to 15% moisture prior to activation;

FIG. 4 provides data illustrating the on size yield (4×12) for dried (15% moisture) and undried (31% moisture) lignite when held in the furnace for 45 to 55 minutes;

FIG. 5 provides graphical data showing the furnace yield and the 4×12 yield for lignite having an initial moisture content of 31% and the same material dried to a moisture level of 15%;

FIG. 6 provides data that show the VFD and H₂S capacity of undried and dried lignite after activation; and

FIG. 7 illustrates data that show the VFD and H₂S capacity (using the modified D6466 method) of undried lignite after activation at various hold times.

These and other features of the present embodiments will be understood better by reading the following detailed description, taken together with the figures herein described. The accompanying drawings are not intended to be drawn to scale. In the drawings, each identical or nearly identical component that is illustrated in various figures may be represented by a like numeral. For purposes of clarity, not every component may be labeled in every drawing.

### DETAILED DESCRIPTION

When lignite coal based activated carbon (AC) is produced, the product from the activation furnace is screened by granule size into several fractions to fit different products. Large granules above +10 mesh are in high demand and constitute many of the higher margin lignite products. Increasing the yield of this fraction would increase the value of the production run. One way of increasing yield is to increase the hardness of the granules as harder granules will break down less during processing. In typical AC production, lignite is added directly to the kiln or furnace and the water contained in the lignite is driven off quickly by the high temperatures of the kiln. As a result, there has been no need to dry the lignite before activation. As detailed below, the inventors have found that by drying the lignite feed before activation, higher ball pan hardness values are obtained on the finished activated carbon. Pre-drying slowly may require a separate process step before activation and may also require modification to the activation equipment and run parameters. For instance, key process integration steps can include using gentle drying equipment (e.g., heated screw conveyors or fluidized bed dryers) and minimizing attrition before activation.

Activated carbon is typically produced by subjecting a carbon source to high temperatures in an oxidizing environment. For instance, steam activation includes providing a source of steam to the carbon at a temperature of greater than 600, 700 or 800° C. This results in increased porosity of the material, providing it with the adsorption characteristics that make it so useful. Sources of carbon to produce AC include wood, coal and coconut shells. Of the different types of coal that can be used, this disclosure is directed to lignite. Lignite contains higher moisture content than bituminous coal and also typically includes a higher ash content. The water content can be, for example, 30 to 40%, typically about 35% by weight.

When lignite is used to produce AC, the moisture present in the lignite is quickly driven off by the high temperature of the activation process. Thus, the process can be achieved in a single step, feeding untreated lignite into a steam activation kiln and collecting the AC at the end of the kiln.

It has been found that by pre-drying the lignite before the activation process, the resulting AC is harder, distributed among larger granule sizes and concurrently less powder. This is preferable material in that it provides a higher yield of valuable AC, is resistant to breakage and size reduction, and produces less dust.

Lignite may be dried, or partially dried prior to activation. Feedstock typically holds about 35% water, by weight. Drying can include removing more than 20%, more than 40%, more than 60% or more than 80% by weight of the moisture naturally present in the lignite. In some embodiments, the moisture content of the lignite can be reduced to less than 30%, less than 25%, less than 20% or less than 15%, by weight. In many cases, the moisture content does not need to be reduced to zero and can be, for instance, greater than 10%, greater than 15% or greater than 20%, by weight, in the pre-dried lignite. As used herein, all values for lignite are provided on a wt/wt basis unless otherwise noted.

The lignite can be pre-treated (dried) in a furnace, oven, fluid bed dryer, heating screws or indirect kiln, for example. The lignite can be treated on a batch or continuous basis and can be exposed to temperatures of greater than 60° C., greater than 80° C. or greater than or equal to 100° C. In many embodiments, the lignite need not be heated to greater than 100° C., greater than 90° C. or greater than 80° C. The lignite can be exposed to these temperatures for greater than 5 min, greater than 10 min, greater than 20 min or greater than 30. In some cases, the heat is ramped up from ambient temperature to a temperature of 80° C. or 100° C., for example, over a period of 5, 10, 15, 20 or 30 minutes. The heat source for drying the lignite can be a gas fired heater, electric heater, or can be heat (waste heat) from the downstream activation kiln. The additional energy required can be minimized when heat from the activation kiln is used. In some embodiments, the temperature in the activation kiln is more easily maintained because less energy is required to drive off the moisture at the activation stage.

The resulting activated carbon can exhibit physical characteristics that improve yield and quality. For instance, the pre-treated lignite can produce an activated carbon that has a ball pan hardness (ASTM 3802) that is significantly greater than the resulting material without pre-treatment. For example, compared to the same lignite, the pre-dried material can increase the ball pan hardness of the resulting activated carbon by more than 10, more than 20 or more than 30. In similar or the same embodiments, the pre-drying can increase the resulting ball pan hardness by more than 20%, more than 50%, more than 75% or more than 100%.

Granule size of pre-treated lignite is greatly improved compared to the undried material. For instance, undried lignite produces granules where more than 18% are less than 30 mesh, more than 30% are less than 20 mesh, and more than 65% are less than 12 mesh. In contrast, the pre-treated lignite can produce a granule distribution where less than 13% of granules are below 30 mesh, less than 22% are below 20 mesh and less than 55% are below 12 mesh. The resulting activated carbon can exhibit excellent porosity and adsorption capability.

### EXAMPLES

### Example 1: Undried Vs Dried Lignite Activations

Lignite Coal with the following properties was used for this work:

| | | Volatile | | | |
|---|---|---|---|---|---|
| | Moisture | Matter | Ash | Carbon | BTU |
| Lignite Coal | Content | Content | Content | Content | Value |
| Average Value | 32.03 | 28.27 | 7.71 | 31.89 | 7470.12 |
| Standard Deviation | 1.27 | 1.77 | 1.70 | 1.61 | 291.23 |

A lignite coal was steam activated in a lab rotary kiln with and without pre-drying as follows:

### Undried (Control)

The kiln was charged with 2 kg of the lignite coal and heated up under flowing nitrogen according to the temperature profile provided below in Table 1. At approximately 790° C., steam flow was initiated and maintained at 10 lb/hr for the duration of the run. After cooling, the product was analyzed for screen yields, vibrating feed density, and H₂S adsorption capacity by a modified ASTM 6646 test (see below).

TABLE 1

| Time | Temperature |
|---|---|
| Minutes | ° C. |
| 0 | 23 |
| 10 | 100 |
| 20 | 154 |
| 30 | 212 |
| 40 | 274 |
| 50 | 314 |
| 60 | 337 |
| 70 | 374 |
| 80 | 582 |
| 90 | 790 |
| 100 | 811 |
| 110 | 803 |
| 120 | 799 |
| 130 | 815 |

### Dried (Pre-Treated)

In a separate run, 2 kg of lignite coal 1 was pre-dried for 1 hour at 80° C. to 15.8% moisture. Subsequently, the dried coal was steam activated according to the profile provided in Table 2. As above, steam was introduced at 10 lb/hr upon reaching 790° C. The same testing as in the above case was used on the pre-dried product

TABLE 2

| Time | Temperature |
|---|---|
| Minutes | ° C. |
| 0 | 26 |
| 10 | 56 |
| 20 | 65 |
| 30 | 77 |
| 40 | 80 |
| 50 | 78 |
| 60 | 90 |
| 70 | 53 |
| 80 | 98 |
| 90 | 132 |
| 100 | 199 |
| 110 | 265 |
| 120 | 314 |
| 130 | 341 |
| 40 | 422 |
| 150 | 606 |
| 160 | 787 |
| 170 | 815 |
| 180 | 808 |
| 190 | 805 |
| 200 | 806 |

### Comparison

The run with pre-dried coal shows comparable product yield, density and H₂S capacity to the undried run. However, the screen yields of the most desired granular components (4×12 fraction) are substantially higher, and the screen yields of the less desired smaller particles are reduced (12×20, 20×30, less than 30 mesh).

TABLE 3

| Variable | Unit | Undried | Dried |
|---|---|---|---|
| Yield | g product/g feed × | 20.9 | 21.5 |
| | 100 | | |
| Product Density (6 × 20 | g/mL | 0.50 | 0.50 |
| fraction) | | | |
| H₂S Capacity (4 × 12 fraction) | g H₂S/mL carbon | 0.2 | 0.2 |
| Screen Yields | | | |
| +4 | wt % | 3 | 5 |
| 4 × 12 | wt % | 28 | 42 |
| 12 × 20 | wt % | 37 | 33 |
| 20 × 30 | wt % | 13 | 8 |
| Minus 30 | wt % | 19 | 12 |

### Example 2: Undried Vs Pre-Dried Lignite

Lignite coal 2 was sieved to a 4×8 fraction. One portion was pre-dried at 110° C. for 24 hours. 400 g each of dried and undried samples were steam activated using a lab rotary kiln for 1.5 hours at 900° C. (isothermal conditions) at a steam rate of 100 g/hr. Like example 1, a comparison shows a significant boost in large granular yield from pre-drying.

TABLE 4

| Variable | Unit | Undried | Dried |
|---|---|---|---|
| Screen Yields | | | |
| +6 | wt % | 3 | 4 |
| 6 × 8 | wt % | 24 | 43 |
| 8 × 10 | wt % | 19 | 23 |
| 10 × 12 | wt % | 7 | 4 |
| −12 | wt % | 47 | 26 |

### Example 3: Effect of Pre-Drying Lignite on Ball Pan Hardness of Activated Carbon

A series of activation experiments were conducted to evaluate the impact of lignite moisture content on the mechanical hardness of the resulting activated carbon. Lignite coal was subjected to three different pre-treatment conditions to obtain varying moisture levels: (i) undried, with a moisture content of approximately 35% by weight; (ii) partially dried, with a moisture content of approximately 12% by weight; and (iii) heavily dried, with a moisture content of approximately 1% by weight.

All samples were heat treated at a temperature of 900° C. under inert conditions (i.e., no steam introduced), with a total heat hold time of 30 minutes. Following heat treatment and cooling, the samples were screened to the target mesh size and evaluated for mechanical durability using the standard Ball Pan Hardness test method (ASTM D3802). The results of the hardness testing are summarized in Table 5, below:

TABLE 5

| Moisture Content (wt %) | Ball Pan Hardness |
|---|---|
| 35% (Undried) | 16% |
| 12% (Partially Dried) | 52% |
| 1% (Heavily Dried) | 52% |

The data indicate a substantial improvement in product hardness upon pre-drying. Specifically, both partially and heavily dried samples exhibited a Ball Pan Hardness value of 52%, more than triple the hardness of the undried sample. Notably, the result for the 12% moisture sample was equivalent to that of the 1% moisture sample, demonstrating that complete removal of moisture is not required to achieve maximum hardness enhancement. Partial drying is sufficient to realize the mechanical durability benefits associated with this process.

### Example 4: Influence of Drying and Charring on Granule Size Distribution of Activated Carbon

A study was conducted to assess the effect of various thermal pre-treatment conditions on the granule size distribution of activated carbon derived from lignite. Four samples of lignite coal (Coal 3), each sieved to a 4×8 mesh fraction, were subjected to the following pre-treatment conditions prior to activation:
a. No treatment (control),
b. Drying at 110° C. for 24 hours,
c. Charring at 500° C. for 30 minutes under inert conditions,
d. Drying followed by charring using the same respective parameters.

All samples were subsequently activated using a rotary kiln at 900° C. with steam introduced at a rate of 100 g/hr for 1.5 hours. Following activation and cooling, each sample was sieved to determine the particle size distribution across standard mesh ranges. The results are summarized in Table 6.

TABLE 6
Granule Size Distribution After Activation (wt %)

| Mesh Size | No Treatment | Dried | Charred | Dried & Charred |
|---|---|---|---|---|
| +6 | 2.6% | 4.2% | 2.1% | 2.1% |
| 6 × 8 | 23.7% | 42.8% | 23.1% | 38.8% |
| 8 × 10 | 19.4% | 23.3% | 20.1% | 24.5% |
| 10 × 12 | 7.4% | 4.1% | 9.3% | 7.9% |
| −12 | 46.9% | 25.6% | 45.4% | 26.7% |

The data indicate that pre-drying had a significant positive impact on granule size distribution. Specifically, the dried samples exhibited a substantially higher yield in the 6×8 mesh fraction (42.8%) and a marked reduction in fines (−12 mesh: 25.6%) when compared to both the untreated and charred-only samples. The charred-only sample showed a similar distribution to the untreated control, suggesting that charring alone does not significantly influence granule size. The combination of drying and charring yielded results comparable to drying alone, indicating that the primary benefit is attributable to the drying step.

### Example 5: Evaluation of Drying Effects on Hardness and Granule Size without Activation

In another experiment, samples of both dried and undried lignite were charred in the kiln for 30 minutes. The object of this experiment was to show the effect of drying without the added variability that comes from activation. The dried sample showed significant improvement in both ball pan hardness (BPH) and particle size distribution compared to the undried sample when running this 30 minute char (no activation).

TABLE 7

| | | | | | | | | | % +10 |
|---|---|---|---|---|---|---|---|---|---|
| | Temp | Steam | Time | | | | | | Lignite |
| Run | (° C.) | (g/hr) | (min) | % H2O | Yield (g) | BPH | +12 | +10 | Basis |
| Dried | 900 | 0 | 30 | 1% | 138.5 | 50 | 73.3% | 60.5% | 21.0% |
| Undried | 900 | 0 | 30 | 35% | 144.6 | 28 | 64.2% | 47.8% | 17.3% |

### Example 6: Effect of Pre-Drying on Activated Carbon Yield and H₂S Adsorption Capacity in a Full-Scale Activation Protocol

A series of comparative activation experiments were conducted using unsized lignite coal to evaluate the effect of pre-drying on screen yield and H₂S adsorption performance. In these tests, 2,000 grams of lignite feedstock with an initial moisture content of 31.2% by weight was activated in a rotary batch furnace. Activation was carried out by ramping linearly to the temperature over 90 minutes to approximately 800° C. under nitrogen, followed by the introduction of steam at a rate of 10 pounds per hour for the remainder of the run. In one set of runs, the lignite was used as-is (undried), while in a second set, the lignite was pre-dried by ramping from ambient temperature to 80° C. over 30 minutes and holding at that temperature for an additional 30 minutes, resulting in a reduced moisture content of approximately 15.8% by weight. Note that when yields are calculated for pre-dried and undried lignite, they are calculated on a dry weight basis for both.

The activated products were sieved, and the 4×12 mesh fraction was recorded as the target product size for biogas applications. The screen yield of the undried sample was 28.0%, whereas the pre-dried sample achieved a 4×12 screen yield of 42.4%, reflecting a 51% increase in on-size product yield when the material is pre-dried.

To assess adsorption performance, samples were subjected to H₂S capacity testing using both ASTM D6646 and a more rigorous extended biogas breakthrough method (lead-lag configuration, “Modified D6646”). Results indicated that while the undried sample exhibited an H₂S adsorption capacity of 0.79 grams of H₂S per gram of activated carbon, the corresponding pre-dried sample demonstrated a capacity of 0.68 g/g. Although the dried material showed a moderate reduction in capacity (˜14%), further testing demonstrated that this effect could be mitigated by increasing the activation level and lowering the furnace yield (total product weight/feed weight×100) by approximately 1% to match or exceed the performance of undried material. In general, the longer heat treatment time resulted in higher available surface area for the material and lower density. The combined benefits in granule yield and manageable adjustments to activation conditions illustrate the commercial viability and processing advantage of pre-drying lignite prior to activation.

### Example 7: Production Rate Benefit Analysis Based on Pre-Drying of Lignite Feedstock

A comparative analysis was performed using data compiled from multiple activation runs involving both undried and pre-dried lignite coal feedstock. In each case, steam activation was performed in a rotary batch furnace at peak temperatures ranging from 790° C. to 825° C., following a ramp-up under nitrogen. Steam was introduced at a constant rate of 10 lb/hr upon reaching target activation temperature. The hold duration at the end of the temperature ramp was varied to achieve different degrees of activation. Activated carbon products were screened, and the 4×12 mesh fraction was used as the benchmark for on-size yield.

Pre-dried lignite was prepared by heating raw coal from ambient temperature to approximately 80° C. over a 30-minute interval and holding at that temperature for an additional 30 minutes, resulting in a reduced moisture content of approximately 15.8% by weight. Undried lignite retained a natural moisture level of approximately 31.2% by weight.

The pre-dried lignite resulted in a statistically consistent increase in 4×12 mesh product yield relative to undried lignite. A regression analysis of the screen yield data, normalized for activation severity (as measured by furnace yield), indicated that the use of pre-dried lignite increased the on-size (4×12) production yield by approximately 48% on average at constant H₂S capacity (Norit method). At constant furnace yield, the yield enhancement was accompanied by a minor reduction in H₂S adsorption capacity, measured using the Norit test method, when activation conditions remained unchanged.

TABLE 8

| Lignite Coal | | 4 × 12 | Vibratory | Modified D6646 | | |
|---|---|---|---|---|---|---|
| Starting | Furnace | Product | Feed | H₂S capacity | BET Surface | Total Pore |
| Moisture | Yield | Yield | Density | (g H2S/g | Area | Volume |
| content (%) | (%) | (%) | (g/mL) | Carbon) | (m2/g) | (cm3/g) |
| 32 | 18 | 27 | 0.47 | 0.73 | 483 | 0.43 |
| 15 | 19 | 38 | 0.49 | 0.45 | 467 | 0.40 |

The Modified D6646 method was adapted from ASTM D6646. The modified method better reflects carbon based media performance in biogas applications by a factor of 2-3× because of its longer residence time (as compared to 8 seconds) and high H₂S concentration (10,000 ppm). These conditions emphasize kinetic limitations and result in only partial bed utilization before breakthrough.

To better reflect commercial operation, a lead-lag method (Modified D6646) was developed using two reactors and a biogas-like feed gas (high CO₂, low O₂, moderate H₂S). By running past breakthrough for 42 hours, the lead reactor reaches near-equilibrium sulfur loadings that closely match field results. This approach resolves product differences missed by ASTM testing and provides more reliable predictions for plant support and new product development in biogas applications.

To account for this variation, activation parameters were adjusted by increasing the activation severity—i.e., by reducing the furnace yield by approximately 1%-which was sufficient to restore H₂S capacity of the pre-dried product to parity with undried material. The analysis demonstrates that a modest adjustment in activation profile enables full utilization of the pre-drying benefits without compromising product performance, yielding a net increase in throughput of granular product suitable for high-value applications such as biogas desulfurization.

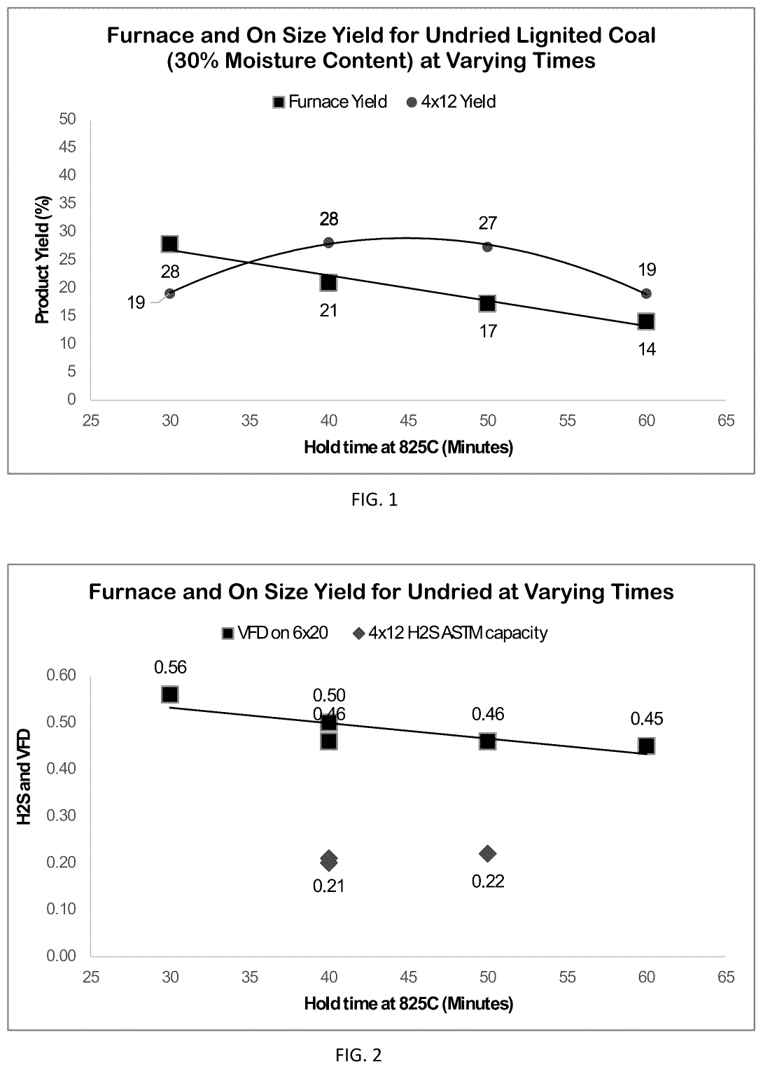

FIGS. 1-7 graphically provide a comparison of the properties of activated carbon made using the processes described herein compared to conventional techniques.

FIG. 1 illustrates the furnace yield and the 4×12 granule size yield at various hold times in the activation stage. Note that 4×12 yield is at a maximum around 40 minutes and the furnace yield is still quite high, at 21 percent. At a higher furnace yield (lower temperature) the 4×12 yield drops to 19%.

FIG. 2 provides data for vibratory feed density (VFD) and H₂S capacity on conventionally processed, undried lignite. As the hold time increases, the VFD (g/mL) drops and the 4×12 H₂S capacity (g H₂S per gram of carbon) increases.

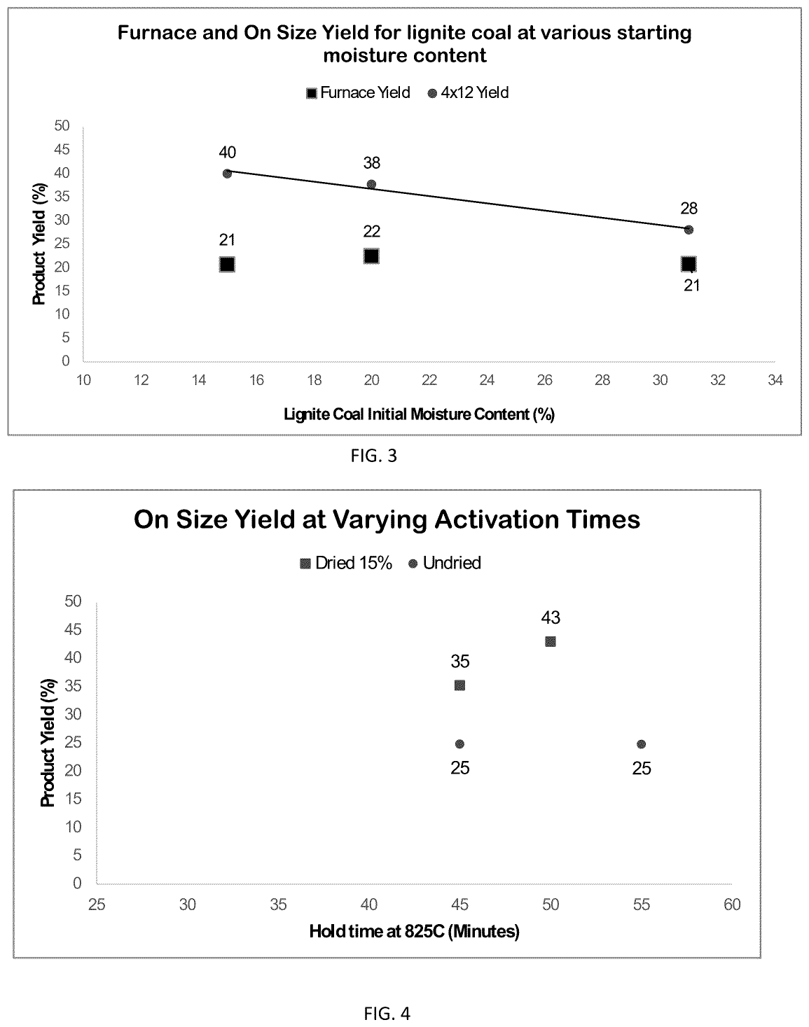

FIG. 3 provides data for furnace yield and 4×12 yield with lignite samples at their natural moisture content (31%), dried to 20% moisture and dried to 15% moisture prior to activation. The data show a consistent furnace yield across the moisture levels and an increasing 4×12 yield as initial moisture levels are decreased.

FIG. 4 provides data illustrating the on size yield (4×12) for dried (15% moisture) and undried (31% moisture) lignite (same material) when held in the furnace for 45 to 55 minutes. At increasing temperature, the data indicate a consistent yield for the undried lignite and an increase in yield from 35% to 43% for the dried material.

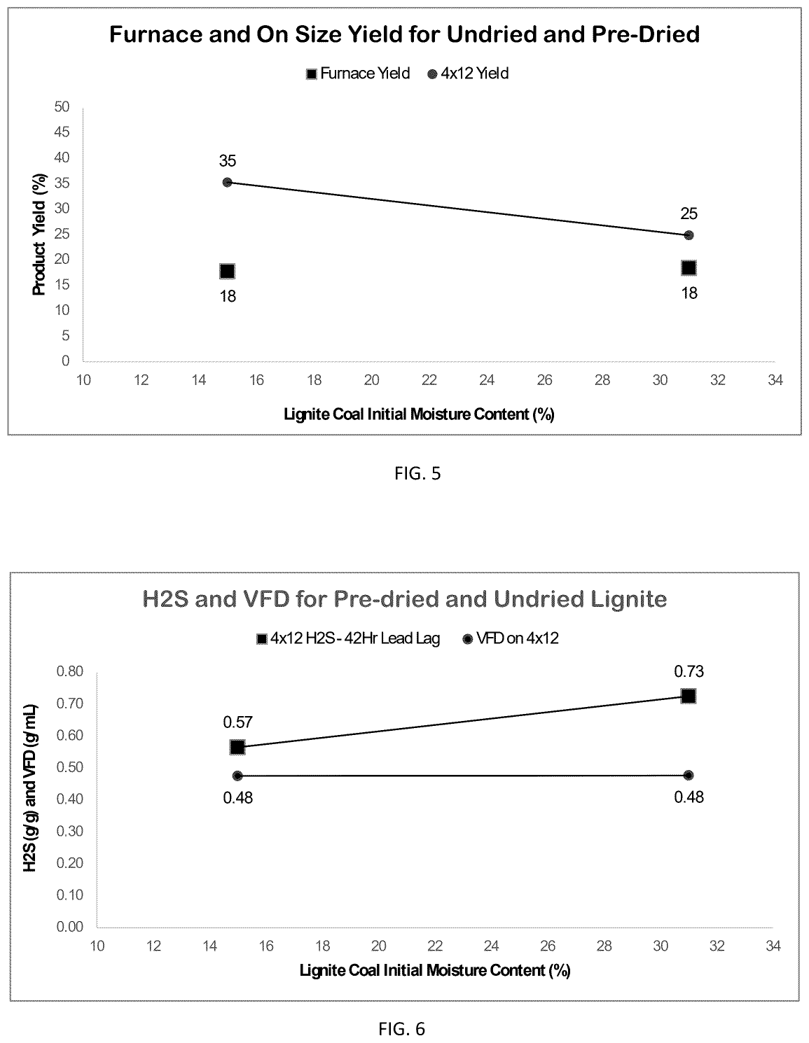

FIG. 5 provides graphical data showing the furnace yield and the 4×12 yield for lignite having an initial moisture content of 31% and the same material dried to a moisture level of 15%. The furnace yield for the lignite did not change with moisture levels, but the 4×12 yield did, with a yield of 25% for the undried material and 35% for the pre-dried material.

FIG. 6 provides data that show the VFD and H₂S capacity (using the modified D6466 method) of undried and dried lignite after activation. The data indicate an increase in H₂S capacity at higher moisture levels and a consistent VFD for pre-dried and undried material.

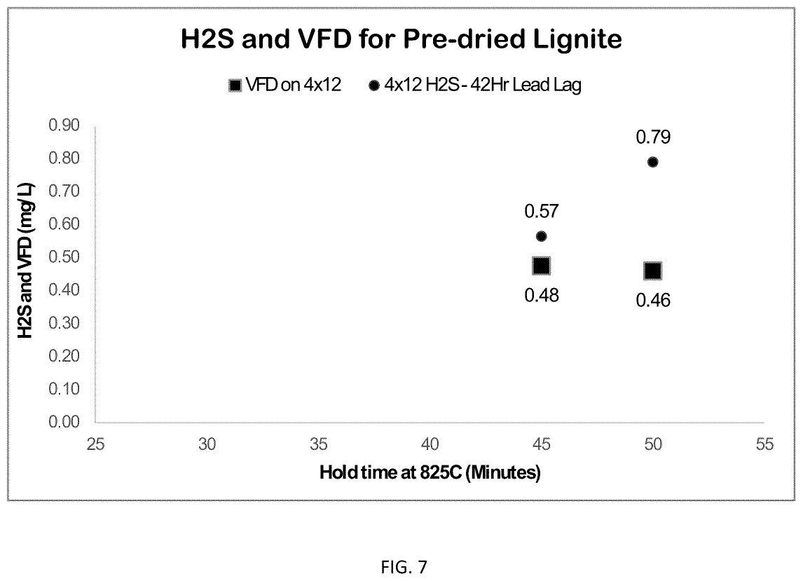

FIG. 7 illustrates data that show the VFD and H₂S capacity (using the modified D6466 method) of pre-dried lignite after activation with various hold times. The data indicate that increasing hold time increases the 4×12 H₂S capacity but slightly decreases the 4×12 VFD.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

1. A method of producing activated carbon, the method comprising:
drying lignite to reduce the moisture content in the lignite to less than 20% by weight and produce a dried lignite; and
activating the dried lignite to produce an activated carbon, at least 70% of the activated carbon having a particle size of 20 mesh or greater.

2. The method of claim 1 wherein the activated carbon exhibits a ball pan hardness of greater than 30.

3. The method of claim 1 wherein drying the lignite comprises drying the lignite for at least 20 minutes.

4. The method of claim 1 wherein drying the lignite comprises drying the lignite at a temperature greater than or equal to 60° C.

5. The method of claim 1 wherein activating comprises steam activation reaching a temperature of at least 750° C.

6. The method of claim 5 wherein steam is provided at a ratio of at least 0.8 kg water per kg of dried lignite.

7. The method of claim 1 wherein the H₂S capacity by ASTM 6646-03 of the activated carbon is at least 0.1 g/mL.

8. The method of claim 1 wherein the dried lignite comprises greater than 5% water by weight.

9. The method of claim 1 wherein the lignite contains greater than 30% water by weight prior to drying.

10. The method of claim 1 wherein at least 30%, by weight, of the activated carbon exhibits a granule size of 6×8 or greater.

11. The method of claim 1 wherein no more than 40% of the activated carbon exhibits a granule size of −12 or smaller.

12. The method of claim 1 wherein the activation process includes activating at a temperature greater than 850° C. for a period of at least 30 minutes.

13. The method of claim 12 comprising activating at a temperature greater than 850° C. for a period of at least 40 minutes.

14. The method of claim 12 comprising activating at a temperature greater than 850° C. for a period of at least 50 minutes.
